(19) United States
(12) Patent Application Publication
(10) Pub. No.: US 2026/0225540 A1
(43) Pub. Date: Aug. 6, 2026

(54) VIBRATION REDUCTION DEVICE

(71) Applicant: SUBARU CORPORATION, Tokyo (JP)

(72) Inventor: Kou SASAKI, Tokyo (JP)

(21) Appl. No.: 19/428,817

(22) Filed: Dec. 22, 2025

(30) Foreign Application Priority Data
Feb. 3, 2025 (JP) 2025-016127

(51) Int. Cl. B60R 13/08; G10K 11/178

(52) U.S. Cl. CPC B60R 13/0815; G10K 11/1785; G10K 2210/1081; G10K 2210/1282; G10K 2210/129; G10K 2210/3056; G10K 2210/501

(57) ABSTRACT

A vibration reduction device configured to reduce vibration perceived by an occupant of a mobile object includes a vibration generator and a control device. The control device is configured to control drive of the vibration generator. The control device is configured to detect a direction, an amplitude, and a phase of swing of a head of the occupant. The control device is configured to set a sound pressure of air vibration to be generated by the vibration generator based on the direction and the amplitude of the swing. The control device is configured to set a phase of the air vibration based on the phase. The control device is configured to control the drive of the vibration generator to generate the air vibration based on the set sound pressure and the set phase.

### CROSS-REFERENCE TO RELATED APPLICATIONS

The present application claims priority from Japanese Patent Application No. 2025-016127 filed on February 3, 2025, the entire contents of which are hereby incorporated by reference.

### BACKGROUND

The disclosure relates to a vibration reduction device. An aspect of the disclosure provides a vibration reduction device configured to reduce vibration perceived by an occupant of a mobile object. The vibration reduction device includes a vibration generator and circuitry. The circuitry is configured to detect a direction, an amplitude, and a phase of swing of a head of the occupant. The circuitry is configured to set a sound pressure of air vibration to be generated by the vibration generator based on the direction and the amplitude of the swing. The circuitry is configured to set a phase of the air vibration based on the phase. The circuitry is configured to control drive of the vibration generator to generate the air vibration based on the set sound pressure and the set phase.

Hitherto, it is known that noise in a vehicle cabin is actively controlled by generating a sound that cancels the noise.

For example, Japanese Unexamined Patent Application Publication (Translation of PCT Application) (JP-T) No. 2014-514607 discloses that, when a buffeting phenomenon occurs in a vehicle cabin, a window panel of the vehicle cabin is vibrated by an actuator to generate a canceling sound wave for canceling the buffeting phenomenon.

Japanese Unexamined Patent Application Publication (JP-A) No. 2007-269244 discloses that a second noise generated in a vehicle based on a first noise generated from a noise source such as an engine of the vehicle is reduced by a third noise serving as a canceling noise for the second noise.

### SUMMARY

An aspect of the disclosure provides a vibration reduction device configured to reduce vibration perceived by an occupant of a mobile object. The vibration reduction device includes a vibration generator and a control device. The control device is configured to control drive of the vibration generator. The control device is configured to detect a direction, an amplitude, and a phase of swing of a head of the occupant. The control device is configured to set a sound pressure of air vibration to be generated by the vibration generator based on the direction and the amplitude of the swing. The control device is configured to set a phase of the air vibration based on the phase. The control device is configured to control the drive of the vibration generator to generate the air vibration based on the set sound pressure and the set phase.

### BRIEF DESCRIPTION OF THE DRAWINGS

FIG. 1 is a schematic diagram illustrating a configuration example of a vehicle including a vibration reduction device according to an embodiment of the disclosure;

FIG. 2 is a block diagram illustrating a configuration example of a vibration reduction device according to an embodiment of the disclosure;

FIG. 3 is a flowchart illustrating an operation example of a control device of the vibration reduction device according to the embodiment of the disclosure;

FIG. 4 is a table indicating the relationships between directions of acceleration and sound pressures at the external auditory canals of an occupant;

FIG. 5 is a diagram illustrating cancellation by air vibration;

FIG. 6 is a block diagram illustrating a configuration example of a vibration reduction device according to an embodiment of the disclosure;

FIG. 7 is a flowchart illustrating an operation example of a control device of the vibration reduction device according to the embodiment of the disclosure; and

FIG. 8 is a diagram illustrating masking by air vibration.

### DETAILED DESCRIPTION

As in the technologies disclosed in JP-T No. 2014-514607 and JP-A No. 2007-269244, the consideration of only the sound wave for canceling the vibration sound of the vehicle is not sufficient to reduce vibration perceived by an occupant of a mobile object such as the vehicle due to vibration of the mobile object.

It is desirable to improve the technology for reducing vibration perceived by an occupant of a mobile object due to vibration of the mobile object.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure.

Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. First Embodiment

### 1-1. Overall Configuration of Mobile Object

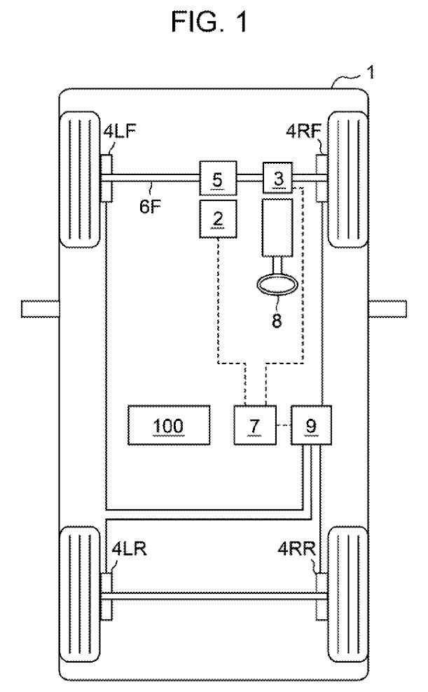

An example of an overall configuration of a vehicle 1 corresponding to a mobile object including a vibration reduction device 100 according to an embodiment of the disclosure will be described with reference to FIG. 1. The mobile object in the embodiment of the disclosure is not limited to the four-wheeled vehicle 1 illustrated in FIG. 1, and may be a train or a motorcycle, or may be a flying object such as an airplane or a helicopter.

The vehicle 1 is a two wheel-drive, four-wheeled automobile that transmits drive torque output from a drive power source 2 that generates drive torque to a left front wheel and a right front wheel. The drive power source 2 may include an internal combustion engine such as a gasoline engine or a diesel engine, may include a drive motor, or may include both the internal combustion engine and the drive motor.

The vehicle 1 may be a four wheel-drive vehicle that transmits drive torque to front wheels and rear wheels. The vehicle 1 may be, for example, an electric vehicle including two drive motors that are a front-wheel drive motor and a rear-wheel drive motor, or may be an electric vehicle including drive motors corresponding to respective wheels. When the vehicle 1 is an electric vehicle or a hybrid electric vehicle, the vehicle 1 is equipped with a secondary battery that stores electric power to be supplied to a drive motor, and a generator such as a motor or a fuel cell that generates electric power to charge the battery.

The vehicle 1 includes the drive power source 2, an electric steering device 3, and brake devices 4LF, 4RF, 4LR, and 4RR (hereinafter collectively referred to as "brake devices 4" when distinction is not particularly required) as devices to be used for driving control on the vehicle 1. The drive power source 2 outputs drive torque that is transmitted to a front-wheel drive axle 6F via a transmission (not illustrated) and a differential mechanism 5. Drive of the drive power source 2 and the transmission is controlled by a vehicle control unit 7 including one or more electronic control units (ECUs).

The electric steering device 3 includes an electric motor (not illustrated) and a gear mechanism (not illustrated). The electric steering device 3 is provided in the vehicle 1 to adjust the steering angle of the front wheels by being controlled by the vehicle control unit 7. The vehicle control unit 7 controls the electric steering device 3 based on the steering angle of a steering wheel 8 by a driver who drives the vehicle.

The brake devices 4LF, 4RF, 4LR, and 4RR apply braking forces to the respective wheels. The brake device 4 may be, for example, a hydraulic brake device. In this case, the hydraulic pressure to be supplied to each brake device 4 is adjusted by controlling drive of a hydraulic unit 9 by the vehicle control unit 7. When the vehicle 1 is an electric vehicle or a hybrid electric vehicle, the brake devices 4 are used in combination with regenerative braking by the drive motors.

The vehicle control unit 7 includes one or more electronic control units (ECUs) that control drive of the drive power source 2, the electric steering device 3, and the hydraulic unit 9. When the vehicle 1 includes a transmission that changes the speed of the output from the drive power source 2 and transmits the output to the wheels, the vehicle control unit 7 has a function of controlling drive of the transmission.

### 1-2. Vibration Reduction Device

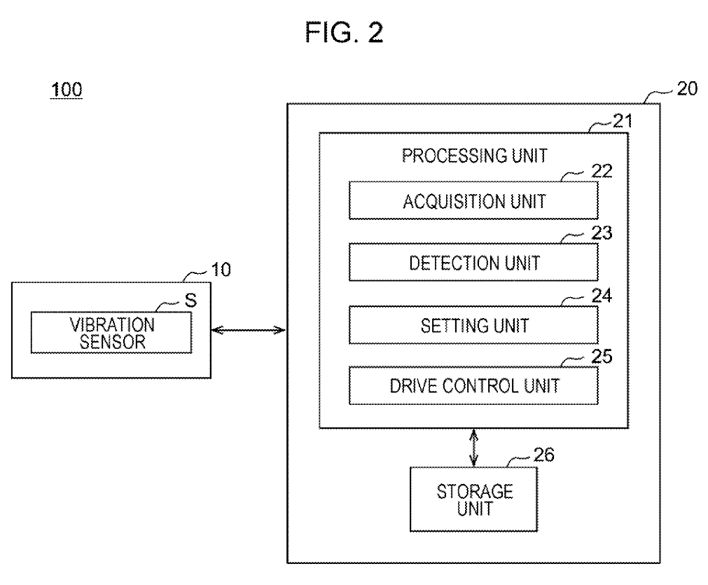

The vibration reduction device 100 according to the first embodiment will be described with reference to FIG. 2.

### 1-2-1. Configuration Example

The vibration reduction device 100 is a device that reduces vibration perceived by an occupant of the vehicle 1 corresponding to the mobile object. The vibration reduction device 100 includes a vibration generator 10 and a control device 20.

### Vibration Generator

The vibration generator 10 is headphones that are worn on the head of an occupant (e.g., the driver) of the vehicle 1 corresponding to the mobile object and generate air vibration described later in the external auditory canals of the occupant. The headphones include a vibration sensor S such as an acceleration sensor or an angular velocity sensor. The vibration sensor S can detect vibrations in a front-rear direction, a vehicle width direction, and a height direction of the vehicle 1.

It is preferable that calibration of coordinate axes of the vibration sensor S be performed at a timing at which the occupant is seated while wearing the headphones. Specifically, an up-down direction of the vibration sensor S is set as a Z-axis direction, and calibration is performed such that the Z-axis direction coincides with the gravity direction. In this case, an X-axis direction is set to be orthogonal to the Z-axis direction and parallel to speaker planes of the headphones. A Y-axis direction is set to be orthogonal to the Z-axis direction and perpendicular to the speaker planes of the headphones. However, the setting of the coordinate axes in the embodiment of the disclosure is not limited thereto, and the coordinate axes may be set as appropriate.

### Control Device

The control device 20 is provided in the vehicle 1 and can communicate with the headphones corresponding to the vibration generator 10 by wired or wireless communication. The vehicle control unit 7 may also have functions of the control device 20 described later, or the control device 20 may be built in the headphones corresponding to the vibration generator 10.

The control device 20 functions as a device that controls drive of the vibration generator 10 by one or more processors such as central processing units (CPUs) executing a computer program. The computer program is a computer program for causing the processor to execute operations described later that are to be executed by the control device 20. The computer program to be executed by the processor may be recorded in a recording medium functioning as a storage unit (memory) 26 described later, or may be recorded in a recording medium built in the control device 20 or any recording medium that can be externally attached to the control device 20.

Recording media that record the computer program may be magnetic media such as hard disk drives, floppy disks, and magnetic tapes, optical recording media such as CD-ROMs, DVDs, and Blu-ray (registered trademark) discs, magneto-optical media such as floptical disks, memory devices such as RAMs and ROMs, flash memories such as USB memories and SSDs, and other media that can store programs.

The control device 20 includes a processing unit 21 and the storage unit 26.

### Processing Unit

The processing unit 21 includes one or more processors such as CPUs. The processing unit 21 may include various peripheral components. Part or all of the processing unit 21 may be configured by updatable firmware or the like, or may be a program module or the like executed by a command from a CPU or the like.

### Storage Unit

The storage unit 26 is configured by one or more memories such as a RAM or a ROM communicatively coupled to the processing unit 21. However, the type of the storage unit 26 and the number of the storage units 26 are not particularly limited. The storage unit 26 stores information such as the computer program to be executed by the processing unit 21, various parameters to be used for arithmetic processing, detection results, and arithmetic results.

### 1-2-2. Functional Configuration of Processing Unit

An example of a functional configuration of the processing unit 21 of the control device 20 will be described. The processing unit 21 includes an acquisition unit 22, a detection unit 23, a setting unit 24, and a drive control unit 25. Each of the acquisition unit 22, the detection unit 23, the setting unit 24, and the drive control unit 25 is a function implemented by execution of the computer program by one or more processors such as CPUs. However, part or all of the acquisition unit 22, the detection unit 23, the setting unit 24, and the drive control unit 25 may be configured using an analog circuit.

### Acquisition Unit

The acquisition unit 22 acquires a sensor signal from the vibration sensor S of the headphones corresponding to the vibration generator 10.

### Detection Unit

The detection unit 23 detects the direction, amplitude, and phase of swing of the head of the occupant based on the sensor signal acquired by the acquisition unit 22. The details will be described later.

### Setting Unit

The setting unit 24 sets a sound pressure of air vibration to be generated by the headphones corresponding to the vibration generator 10 based on the direction and amplitude of the swing of the head detected by the detection unit 23. The setting unit 24 sets a phase of the air vibration to be generated by the headphones corresponding to the vibration generator 10 based on the phase of the swing of the head detected by the detection unit 23. The details will be described later.

### Drive Control Unit

The drive control unit 25 controls drive of the headphones corresponding to the vibration generator 10 to generate air vibration based on the sound pressure and the phase set by the setting unit 24.

### 1-2-3. Operation Example of Control Device

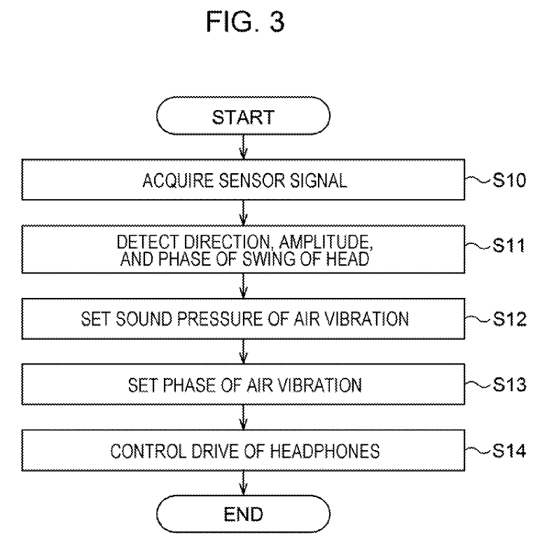

An operation example of the control device 20 according to the present embodiment will be described with reference to a flowchart of FIG. 3.

In this operation example, a case where an occupant wearing headphones is riding on the vehicle 1 corresponding to the mobile object will be described as an example. However, the embodiment of the disclosure is not limited thereto.

In step S10, the acquisition unit 22 acquires a sensor signal from the vibration sensor S of the headphones corresponding to the vibration generator 10. Then, the process proceeds to step S11.

In step S11, the detection unit 23 detects the direction, amplitude, and phase of swing of the head of the occupant based on the sensor signal from the vibration sensor S acquired in step S10. The amplitude may be an amplitude of acceleration, an amplitude of displacement, or amplitudes of acceleration and displacement. Then, the process proceeds to step S12.

In step S12, the setting unit 24 sets a sound pressure of air vibration to be generated by the headphones corresponding to the vibration generator 10 based on the direction and amplitude of the swing of the head detected in step S11. The air vibration to be generated by the headphones preferably has a frequency in an inaudible band lower than the audible band, and more preferably has a frequency in a range of, for example, 5 Hz to 20 Hz. This is because the air vibration relative to air around the head of the occupant that is generated due to the swing of the head caused by vehicle body vibration of the vehicle 1 typically has a frequency in the inaudible band lower than the audible band.

Specifically, the setting unit 24 estimates a sound pressure generated by compression or expansion of air at the external auditory canal of the occupant using the direction and amplitude of the swing of the head detected in step S11. Then, the setting unit 24 sets the estimated sound pressure as the sound pressure of the air vibration to be generated by the headphones corresponding to the vibration generator 10. Hereinafter, the method for estimating the sound pressure will be described more specifically.

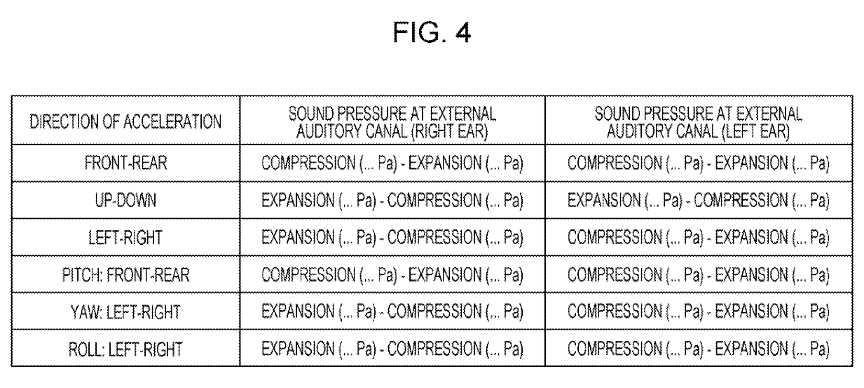

In the estimation of the sound pressure, for example, as illustrated in FIG. 4, a table T indicating the relationships between the directions of the acceleration and the sound pressures at the external auditory canals for each magnitude of the acceleration may be used. The table T is stored in the storage unit 26 in advance, and can be referred to by the setting unit 24 when estimating the sound pressure.

The table T can be created using any device that can measure the magnitude and direction of acceleration and the sound pressure at the external auditory canal. Examples of the device include a known or any earphone microphone and a known or any acceleration sensor. That is, the air vibration at the external auditory canal of the occupant caused by the direction and amplitude of the swing of the head of the occupant is observed in advance and stored in the storage unit 26 as the table T. The table T may be obtained by learning data of a plurality of occupants using deep learning such as a deep neural network (DNN) by an external server or the like that can communicate with the control device 20.

In FIG. 4, "front" means a front side in the front-rear direction of the vehicle 1, and "rear" means a rear side in the front-rear direction of the vehicle 1. "Up" means an upper side in the height direction of the vehicle 1, and "down" means a lower side in the height direction of the vehicle 1. "Left" means a left side in the vehicle width direction of the vehicle 1, and "right" means a right side in the vehicle width direction of the vehicle 1. "Pitch: front" means a front side in a pitch direction of the vehicle 1, and "pitch: rear" means a rear side in the pitch direction of the vehicle 1. "Yaw: left" means a left side in a yaw direction of the vehicle 1, and "yaw: right" means a right side in the yaw direction of the vehicle 1. "Roll: left" means a left side in a roll direction of the vehicle 1, and "roll: right" means a right side in the roll direction of the vehicle 1. "Compression" means compression of air at the external auditory canal. "Expansion" means expansion of air at the external auditory canal. The magnitude of the sound pressure (Pa) is determined as appropriate depending on the magnitude of the acceleration.

As an example, in a case where the direction of the acceleration corresponding to the direction of the swing of the head of the occupant is a direction along the roll direction of the vehicle 1, the setting unit 24 may determine a change in the sound pressure at the external auditory canal associated with the roll direction of the vehicle 1 from the table T based on the magnitude of the acceleration corresponding to the amplitude of the swing of the head. In this way, the setting unit 24 may estimate the change in the sound pressure caused by the compression and expansion of the air in the external auditory canals of the left ear and the right ear of the occupant.

In the estimation of the sound pressure described above, a transfer function indicating the relationship between the direction and amplitude of the swing of the head of the occupant and the air vibration may be used instead of the table T. The transfer function can be calculated as appropriate using any device that can measure the magnitude and direction of the acceleration and the sound pressure at the external auditory canal.

In this way, the setting unit 24 can estimate the sound pressure of the air vibration generated around the head of the occupant due to the swing of the head caused by the vehicle body vibration of the vehicle 1. Then, the setting unit 24 sets the sound pressure thus estimated as the sound pressure of the air vibration to be generated by the headphones corresponding to the vibration generator 10. Then, the process proceeds to step S13.

In step S13, the setting unit 24 sets a phase of the air vibration to be generated by the headphones corresponding to the vibration generator 10 based on the phase of the swing of the head detected in step S11.

Specifically, the setting unit 24 sets, as the phase of the air vibration to be generated by the headphones corresponding to the vibration generator 10, a phase opposite to the phase of the swing of the head detected in step S11. That is, the phase of the air vibration to be generated by the headphones corresponding to the vibration generator 10 is set to be opposite to the phase estimated from the swing of the head of the occupant caused by the vehicle body vibration of the vehicle 1. In this specification, the term "opposite" need not mean "opposite" in a mathematically strict sense, and may mean "opposite" within a range of allowable errors.

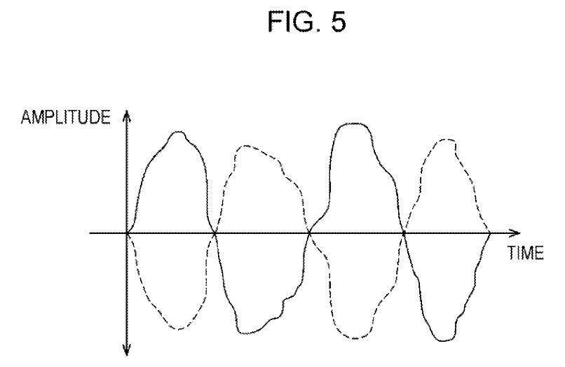

At the sound pressure and phase set in steps S12 and S13, the air vibration is output from the headphones corresponding to the vibration generator 10 in step S14 described later, whereby the following effects are obtained. That is, the air vibration generated around the head due to the swing of the head of the occupant as indicated by the broken line in FIG. 5 is canceled by the air vibration output from the headphones as indicated by the solid line in FIG. 5. As a result, it is possible to reduce the vibration perceived by the occupant due to the vehicle body vibration of the vehicle 1. Steps S12 and S13 need not be executed in this order, and may be executed in reverse order or in parallel. Then, the process proceeds to step S14.

In step S14, the drive control unit 25 controls drive of the headphones corresponding to the vibration generator 10 to generate the air vibration based on the sound pressure set in step S12 and the phase set in step S13.

Specifically, the drive control unit 25 generates a control signal for outputting the air vibration having the sound pressure set in step S12 and the phase set in step S13 from the headphones corresponding to the vibration generator 10. Then, the drive control unit 25 transmits the generated control signal to the headphones by wired or wireless communication. As a result, the air vibration having the sound pressure set in step S12 and the phase set in step S13 is output from the headphones. Then, the process ends.

### 1-3. Effects

As described above, the control device 20 according to the first embodiment detects the direction, amplitude, and phase of swing of the head of the occupant of the vehicle 1 corresponding to the mobile object from the headphones corresponding to the vibration generator 10. Then, the control device 20 sets a sound pressure of air vibration to be generated by the headphones corresponding to the vibration generator 10 based on the detected direction and amplitude of the swing. The control device 20 sets a phase of the air vibration to be generated by the headphones corresponding to the vibration generator 10 based on the detected phase. Then, the control device 20 controls drive of the headphones corresponding to the vibration generator 10 to generate the air vibration based on the set sound pressure and phase.

With such a configuration, it is possible to reduce the vibration perceived by the occupant due to the vibration of the vehicle 1 corresponding to the mobile object. That is, the air vibration relative to the air around the head is generated by the swing of the head due to the vehicle body vibration of the vehicle 1. Since this air vibration is canceled by the air vibration from the headphones, the vibration perceived by the occupant is reduced. As a result, the riding comfort of the vehicle 1 is improved.

### 2. Second Embodiment

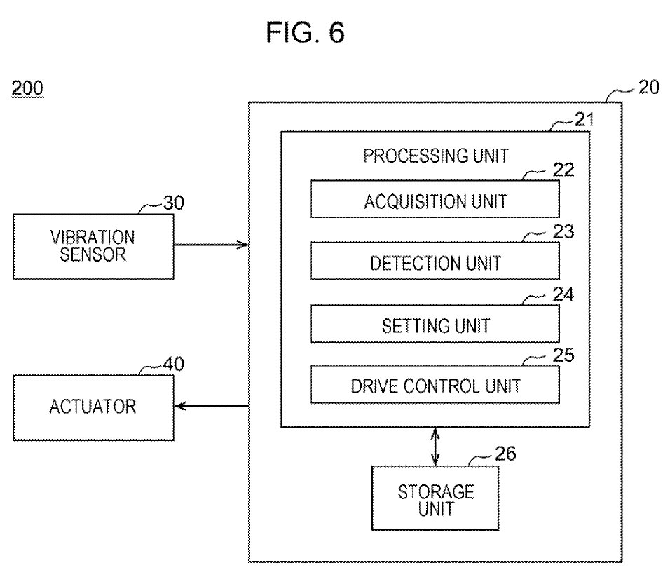

A vibration reduction device 200 according to a second embodiment will be described with reference to FIG. 6. Hereinafter, differences from the vibration reduction device 100 according to the first embodiment will be mainly described. Otherwise, the description in the first embodiment is applied. Therefore, the modification of the first embodiment is also applicable to the second embodiment.

### 2-1. Vehicle

A vibration sensor 30 is provided at a predetermined second position in the vehicle 1 corresponding to the mobile object. The vibration sensor 30 is an acceleration sensor or an angular velocity sensor that can detect floor vibration, seat vibration, or the like of the vehicle 1 corresponding to the mobile object. For example, the vibration sensor 30 may be a suspension stroke sensor or a vertical G sensor provided in a suspension of the vehicle 1, or may be a seat surface pressure sensor or the like provided at a seating position of the occupant of the vehicle 1.

In the second embodiment, the vibration sensor 30 is not limited to the acceleration sensor or the angular velocity sensor that can detect floor vibration, seat vibration, or the like of the vehicle 1 corresponding to the mobile object. The vibration sensor 30 may be the acceleration sensor or a vibration sensor of headphones similar to those in the first embodiment instead of or in addition to the acceleration sensor.

### 2-2. Vibration Reduction Device

The vibration reduction device 200 is a device that reduces vibration perceived by the occupant of the vehicle 1 corresponding to the mobile object. The vibration reduction device 200 includes a vibration generator 40 and the control device 20.

### 2-3. Vibration Generator

The vibration generator 40 is provided at a predetermined first position in the vehicle 1 corresponding to the mobile object. The vibration generator 40 may be an actuator that can vibrate part of the vehicle 1 corresponding to the mobile object. The actuator may be a vibration actuator that can vibrate a roof trim, a rear gate, an in-vehicle woofer, a floor portion of a luggage compartment, or a seat, or may be a brake-related actuator such as a brake booster or an antilock braking system (ABS).

### 2-4. Control Device

The control device 20 is provided in the vehicle 1 and can communicate with the vibration sensor 30 and the actuator corresponding to the vibration generator 40 by wired or wireless communication. The vehicle control unit 7 may also have functions of the control device 20.

### 2-4-1. Configuration Example of Control Device

The acquisition unit 22 of the control device 20 acquires a sensor signal from the vibration sensor 30 provided at the predetermined second position in the vehicle 1 corresponding to the mobile object.

The detection unit 23 of the control device 20 detects the direction, amplitude, and phase of swing of the head of the occupant based on the sensor signal acquired by the acquisition unit 22. The details will be described later.

The setting unit 24 sets a sound pressure of air vibration to be generated by the actuator corresponding to the vibration generator 40 based on the direction and amplitude of the swing of the head detected by the detection unit 23. The setting unit 24 sets a phase of the air vibration to be generated by the actuator corresponding to the vibration generator 40 based on the phase of the swing of the head detected by the detection unit 23. The details will be described later.

The drive control unit 25 controls drive of the actuator corresponding to the vibration generator 40 to generate air vibration based on the sound pressure and the phase set by the setting unit 24.

### 2-4-2. Operation Example of Control Device

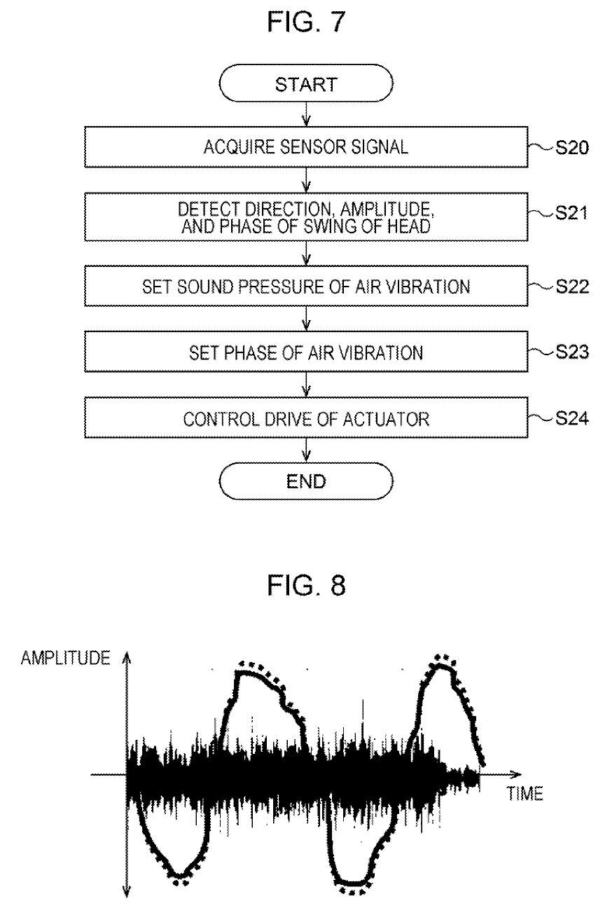

An operation example of the control device 20 according to the present embodiment will be described with reference to a flowchart of FIG. 7.

In this operation example, a case where an occupant is riding on the vehicle 1 corresponding to the mobile object will be described as an example. In this operation example, a case where a seat surface pressure sensor provided at a seating position of the occupant is used as the vibration sensor 30 will be described as an example. In this operation example, a case where an actuator that can vibrate a roof trim of the vehicle 1 corresponding to the mobile object is used as the vibration generator 40 will be described as an example. However, the embodiment of the disclosure is not limited thereto. For example, a vibration sensor of headphones may be additionally or alternatively applied as the vibration sensor 30 similarly to the first embodiment.

In step S20, the acquisition unit 22 acquires a sensor signal from the vibration sensor 30 provided at the predetermined second position in the vehicle 1. When a vibration sensor of headphones is additionally or alternatively applied as the vibration sensor 30, a sensor signal from this vibration sensor is additionally or alternatively acquired. Then, the process proceeds to step S21.

In step S21, the detection unit 23 detects the direction, amplitude, and phase of swing of the head of the occupant based on the sensor signal from the vibration sensor 30 acquired in step S20. The amplitude may be an amplitude of acceleration or an amplitude of displacement.

That is, a table T2 in which the directions, amplitudes, and phases of various vibrations caused by the vehicle body vibration of the vehicle 1 are associated with the directions, amplitudes, and phases of swing of the head of the occupant is created in advance and stored in the storage unit 26 of the control device 20. By referring to the table T2 stored in the storage unit 26, the detection unit 23 selects the direction, amplitude, and phase of the swing of the head corresponding to the direction, amplitude, and phase of the vibration indicated by the sensor signal acquired in step S20, thereby detecting the direction, amplitude, and phase of the swing of the head.

Instead of the table T2, learning data in which the relationship between the vibration observed by the vibration sensor 30 and the swing of the head is learned in advance by a DNN or the like may be used. Alternatively, a transfer function indicating the relationship between the vibration observed by the vibration sensor 30 and the swing of the head may be used. The transfer function can be calculated as appropriate using a known or any vibrator. Then, the process proceeds to step S22.

In step S22, the setting unit 24 sets a sound pressure of air vibration to be generated by the actuator corresponding to the vibration generator 40 based on the direction and amplitude of the swing of the head detected in step S21.

Specifically, the setting unit 24 estimates a sound pressure generated by compression or expansion of air at the external auditory canal of the occupant based on the direction and amplitude of the swing of the head detected in step S21. Then, the setting unit 24 sets the estimated sound pressure as the sound pressure of the air vibration to be generated by the actuator corresponding to the vibration generator 40. The details are the same as those in the first embodiment. Then, the process proceeds to step S23.

In step S23, the setting unit 24 sets a phase of the air vibration to be generated by the actuator corresponding to the vibration generator 40 based on the phase of the swing of the head detected in step S21.

Specifically, the setting unit 24 sets, as the phase of the air vibration to be generated by the actuator corresponding to the vibration generator 40, a phase opposite to the phase of the swing of the head detected in step S21. However, there is a distance from the position of the roof trim provided with the actuator corresponding to the vibration generator 40 to the position of the head (ear) of the occupant. Therefore, the phase of the air vibration is set in consideration of the phase difference corresponding to the distance. For example, the setting unit 24 adjusts as appropriate the timing to output the air vibration using the distance such that the air vibration generated around the head due to the vibration of the vehicle 1 is canceled when the air vibration generated by the actuator corresponding to the vibration generator 40 reaches the ear of the occupant. The position of the ear of the occupant can be determined by performing image processing on an image captured by an in-vehicle camera of the vehicle 1.

In step S22 or S23, the setting unit 24 may set the sound pressure and phase of the air vibration based on information on the orientation of the face of the occupant and the direction, amplitude, and phase of the swing of the head. Thus, it is possible to more accurately calculate the phase difference corresponding to the distance from the position of the roof trim provided with the actuator corresponding to the vibration generator 40 to the position of the head of the occupant. The orientation of the face of the occupant can be acquired as appropriate by performing image processing on an image captured by the in-vehicle camera of the vehicle 1. Steps S22 and S23 need not be executed in this order, and may be executed in reverse order or in parallel. Then, the process proceeds to step S24.

In step S24, the drive control unit 25 controls drive of the actuator corresponding to the vibration generator 40 to generate the air vibration based on the sound pressure set in step S22 and the phase set in step S23.

Specifically, the drive control unit 25 generates a control signal for outputting the air vibration having the sound pressure set in step S22 and the phase set in step S23 from the actuator corresponding to the vibration generator 40. Then, the drive control unit 25 transmits the generated control signal to the actuator by wired or wireless communication. As a result, the air vibration having the sound pressure set in step S22 and the phase set in step S23 is output from the actuator. Then, the process ends.

### 2-5. Effects

As described above, the control device 20 according to the second embodiment detects the direction, amplitude, and phase of swing of the head of the occupant of the vehicle 1 corresponding to the mobile object based on the sensor signal from the vibration sensor 30 at the predetermined second position in the vehicle 1 corresponding to the mobile object. Then, the control device 20 sets a sound pressure of air vibration to be generated by the actuator corresponding to the vibration generator 40 provided at the predetermined first position in the vehicle 1 corresponding to the mobile object based on the detected direction and amplitude of the swing. The control device 20 sets a phase of the air vibration to be generated by the actuator corresponding to the vibration generator 40 based on the detected phase. Then, the control device 20 controls drive of the actuator corresponding to the vibration generator 40 provided at the predetermined first position in the vehicle 1 corresponding to the mobile object to generate the air vibration based on the set sound pressure and phase.

With such a configuration, it is possible to reduce the vibration perceived by the occupant due to the vibration of the vehicle 1 corresponding to the mobile object. That is, the air vibration relative to the air around the head is generated by the swing of the head due to the vehicle body vibration of the vehicle 1. Since this air vibration is canceled by the air vibration from the actuator, the perception by the occupant is reduced. As a result, the riding comfort of the vehicle 1 is improved.

Although the exemplary embodiments of the disclosure are described in detail above with reference to the accompanying drawings, the embodiment of the disclosure is not limited to such embodiments. It will be apparent to persons having ordinary skill in the art that various modifications and variations can be made within the scope of the technical idea described in the appended claims. It is understood that these modifications and variations are pertinent to the technical scope of the disclosure. For example, the functions and the like included in the components, the steps, or the like can be rearranged so as not to be logically inconsistent, and a plurality of components, steps, or the like can be combined into one or divided.

As a modification, in step S12 or S13 or step S22 or S23, the setting unit 24 may additionally execute the following process. That is, the setting unit 24 may set a frequency of additional air vibration to be output by being superimposed on the air vibration output from the headphones corresponding to the vibration generator 10 or the actuator corresponding to the vibration generator 40. At this time, the setting unit 24 may set a frequency in the inaudible band lower than the audible band, and may set a frequency in the range of, for example, 5 Hz to 20 Hz. Thus, for example, high-frequency noise of a motor, an inverter, or the like in an electric automobile or the like indicated by the thin solid line in FIG. 8 is masked by the additional air vibration indicated by the thick solid line or broken line in FIG. 8. In FIG. 8, the thick solid line indicates the air vibration from the actuator, and the thick broken line indicates the air vibration from the headphones. The sound pressure and phase of the additional air vibration are not particularly limited as long as the occupant does not feel discomfort, and can be set as appropriate.

The setting unit 24 may perform the above masking when the acceleration of the vehicle 1 is equal to or greater than a threshold. At this time, the acceleration of the vehicle 1 may be calculated based on a sensor signal from an acceleration sensor (not illustrated) that is provided in the vehicle 1 and detects the acceleration of the vehicle 1. Alternatively, the acceleration of the vehicle 1 may be estimated based on a DC component of the vibration sensor S of the headphones.

The technology of the embodiment of the disclosure can also be implemented as the vehicle 1 equipped with the vibration reduction device 100 or 200 described in the above embodiments, a vibration reduction method to be performed by the vibration reduction device 100 or 200, a computer program that causes a computer to function as the control device 20 described in the above embodiments, and a non-transitory tangible recording medium on which the computer program is recorded.

According to the embodiment of the disclosure, it is possible to reduce the vibration perceived by the occupant of the mobile object due to the vibration of the mobile object.

The control device 20 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 20 including the acquisition unit 22, the detection unit 23, the setting unit 24, and the drive control unit 25. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A vibration reduction device configured to reduce vibration perceived by an occupant of a mobile object, the vibration reduction device comprising:
a vibration generator; and
a control device configured to control drive of the vibration generator, wherein
the control device is configured to
detect a direction, an amplitude, and a phase of swing of a head of the occupant,
set a sound pressure of air vibration to be generated by the vibration generator based on the direction and the amplitude of the swing,
set a phase of the air vibration based on the phase, and
control the drive of the vibration generator to generate the air vibration based on the set sound pressure and the set phase.

2. The vibration reduction device according to claim 1, wherein
the vibration generator is headphones that are configured to be worn on the head and to generate the air vibration in an external auditory canal of the occupant,
the headphones comprise a vibration sensor, and
the control device is configured to
detect the direction, the amplitude, and the phase of the swing of the head based on a sensor signal from the vibration sensor.

3. The vibration reduction device according to claim 1, wherein
the vibration generator is provided at a predetermined first position in the mobile object,
the vibration reduction device further comprises a vibration sensor provided at a predetermined second position in the mobile object, and
the control device is configured to
detect the direction, the amplitude, and the phase of the swing of the head based on a sensor signal from the vibration sensor.

4. The vibration reduction device according to claim 3, wherein the control device is configured to
acquire information on an orientation of a face of the occupant, and
set the sound pressure and the phase of the air vibration based on the information on the orientation of the face and the direction, the amplitude, and the phase of the swing of the head.

5. The vibration reduction device according to claim 3, wherein the vibration generator is an actuator configured to vibrate part of the mobile object.

6. A vibration reduction device configured to reduce vibration perceived by an occupant of a mobile object, the vibration reduction device comprising:
a vibration generator; and
circuitry configured to
detect a direction, an amplitude, and a phase of swing of a head of the occupant,
set a sound pressure of air vibration to be generated by the vibration generator based on the direction and the amplitude of the swing,
set a phase of the air vibration based on the phase, and
control drive of the vibration generator to generate the air vibration based on the set sound pressure and the set phase.
